(19) United States
(12) Patent Application Publication
(10) Pub. No.: US 2024/0316477 A1
(43) Pub. Date: Sep. 26, 2024

(54) METHOD FOR MONITORING A SYSTEM AND ASSOCIATED COMPUTER PROGRAM PRODUCT

(71) Applicants: TotalEnergies OneTech, COURBEVOIE (FR); ECOLE POLYTECHNIQUE, PALAISEAU (FR); Centre national de la recherche scientifique, PARIS (FR)

(72) Inventors: Amin DHAOU, L'HAY LES ROSES (FR); Antoine BERTONCELLO, MARNES LA COQUETTE (FR); Sébastien GOURVÉNEC, ROINVILLE (FR); Josselin GARNIER, PARIS (FR); Erwan LE PENNEC, PARIS (FR)

(73) Assignees: TotalEnergies OneTech, COURBEVOIE (FR); ECOLE POLYTECHNIQUE, PALAISEAU (FR); Centre national de la recherche scientifique, PARIS (FR)

(21) Appl. No.: 18/575,664

(22) PCT Filed: Jul. 1, 2022
(86) PCT No.: PCT/EP2022/068307

§ 371 Date: Dec. 29, 2023

(30) Foreign Application Priority Data
Jul. 1, 2021 (FR) 2107171

(51) Int. Cl. B01D 3/42

(52) U.S. Cl. CPC B01D 3/4211

(57) ABSTRACT

The present invention relates to a method of monitoring a system, comprising the following steps:
i. obtaining time series describing the temporal evolution of a parameter of a system between an initial and a final time, the final time being triggered by the occurrence of an abnormal event affecting the system,
ii. for each time series, defining an abnormal time period and a normal time period,
iii. for each time series, determining a metric characterizing each parameter of the series under consideration over the abnormal time period and over the normal time period,
iv. determining association rules on the basis of the characterizing metrics,
v. validating the obtained association rules, and
vi. the predicting the occurrence or lack of occurrence of an abnormal event liable to affect a system to be monitored on the basis of the validated association rules.

### CROSS REFERENCE TO RELATED APPLICATIONS

The present application is a U.S. National Phase Application under 35 U.S.C. § 371 of International Patent Application No. PCT/EP2022/068307 filed Jul. 1, 2022, which claims priority of French Patent Application No. 21 07171 filed Jul. 1, 2021. The entire contents of which are hereby incorporated by reference.

### FIELD OF THE INVENTION

The present invention relates to a method of monitoring a system. The invention further relates to an associated computer program.

### BACKGROUND

In industry, infrastructures are increasingly complex, so abnormal events, such as breakdowns or deteriorations, are likely to occur repeatedly, without being easy to explain such events. The result therefrom is a significant economic and environmental impact.

For example, oil refining is a method of converting crude oil into a finished product that can be used e.g. as gasoline, diesel or other products used in the petrochemical industry. The distillation step is the first step in such method. Same consists in purifying different substances of liquids from a mixture, e.g. the different hydrocarbon fractions contained in crude oil. However, on a regular basis, an abnormal event called choking, takes place, which requires slowing down or even stopping the transformation method for a relatively long time period. Indeed, many hours of maintenance are required for returning the column to the normal state.

Different methods based on theoretical equations and/or pressure and temperature analyses have been developed to predict chokings in distillation columns used in refineries. There are, however, many erroneous predictions (false positives) or a significant number of unpredicted chokings (false negatives) and are hence unsatisfactory.

A method of obtaining a model for predicting the beginning of choking is also known. Such a model is based on a random forest algorithm. Nevertheless, such a model also generates a significant number of false positives while omitting to predict certain chokings. A waste of time results therefrom, as well as economic losses.

There is thus a need for a method leading to a better prediction of the occurrence of an abnormal event affecting a system.

To this end, the subject matter of the present description is a method of monitoring a system, the method being implemented by computer and comprising:
a. a preparation phase comprising the following steps:
   i. obtaining time series, for at least one system of the same nature as the system to be monitored, each time series describing the time evolution of one or a plurality of predetermined parameters of the system considered between an initial and a final instant, the final instant being triggered by the occurrence of an abnormal event affecting the system in question,
   ii. for each time series, the definition of an abnormal time period and of a normal time period, the end of the abnormal time period coinciding with the occurrence of the abnormal event, the normal time period being an earlier period having the same duration as the abnormal time period and such that the time gap between the normal time period and the abnormal time period is greater than a predetermined gap,
   iii. for each time series, the determination of a metric characterizing each parameter of the series considered, on the one hand over the abnormal time period and on the other hand over the normal time period,
   iv. for a set of time series, called training series, the determination of association rules according to the characterizing metrics obtained for each parameter, each association rule predicting the occurrence or lack of occurrence of an abnormal event by associating data relating to the characterization metric of at least one parameter with the occurrence or lack of occurrence of the abnormal event,
   v. the validation of the association rules obtained on at least one time series, called test series, distinct from the training time series,
b. an operating phase comprising the following steps:
   i. obtaining data relating to the time evolution of the predetermined parameter(s) of the system to be monitored,
   ii. the prediction of the occurrence or lack of occurrence of an abnormal event likely to affect the system based on the data obtained for the system to be monitored and the validated association rules.

According to other particular embodiments, the method comprises one or more of the following features, taken individually or according to all technically possible combinations:
for each normal time period and each abnormal time period, a first sub-period and a second sub-period are defined, the second sub-period having the same duration as the first sub-period and being spaced from the first sub-period by a predetermined length of time, the characterization metric being a rate of change, during the determination step of the characterization metric, a characteristic datum for each parameter considered over the duration of the first sub-period and the second sub-period of the time period considered is calculated for each normal and abnormal time period, the characterization metric of each normal and abnormal time period being obtained on the basis of the characteristic data obtained for the first sub-period and the second sub-period of the time period considered;
during the step of determining the association rules, the characterizing metrics are classified into a plurality of classes according to the value obtained for each characterization metric, during the step of determining the association rules, the data relating to the characterization metric being the class to which the characterization metric belongs so that each association rule associates a class of a characterization metric of at least one parameter with the occurrence or lack of occurrence of an abnormal event;
the determined association rules are at most a predetermined number of rules selected from a set of rules established depending on the characterizing metrics of the parameters over all training time series, the selected rules being rules the frequency of occurrence of which in the time series considered is greater than an occurrence threshold,
preferentially, the selected rules being the rules having the highest confidence metric among the rules, the frequency of occurrence in the time series considered is greater than an occurrence threshold, the confidence metric evaluating the frequency of veracity of the rule over the time series considered,
preferentially, the selected rules being the rules with the lowest independence rate among the rules the frequency of occurrence of which in the time series considered is greater than an occurrence threshold and the confidence metric of which is the highest, the independence rate quantifying the independence of associations made by a rule,
preferentially, the selected rules being the rules with the highest conviction metric among the rules, the frequency of occurrence of which in the time series considered is greater than an occurrence threshold, the confidence metric of which is the highest and the independence rate of which is the lowest, the conviction metric quantifying the frequency of non-veracity of the rule over the time series considered;
during the validation step, a prediction is obtained for each of the association rules on the test time series considered, the final prediction being obtained by aggregating the predictions obtained for each of the association rules according to an aggregation criterion, the association rules being validated when the final prediction corresponds to the proven prediction of an abnormal event during the test time series;
the rules of association comprise rules predicting the occurrence of an abnormal event, and rules predicting the absence of an abnormal event;
the preparation phase comprises the repetition of the steps of determining association rules and validation rules for different sets of training time series so that each time series was once a test time series and during the other repetitions a training time series;
the operating phase comprises a step of generating an alert and/or triggering a system control action when an abnormal event is predicted;
the system to be monitored is a distillation column and the abnormal event is a choking of the distillation column.

The present description further relates to a computer program product comprising program instructions stored on a computer-readable storage medium, for the execution of a method as described above when the computer program is executed on a computer.

The present description further relates to a readable information medium on which is stored a computer program product such as described hereinabove.

Other features and advantages of the invention will appear upon reading hereinafter the description of the embodiments of the invention, given only as an example, and making reference to the following drawings:

### BRIEF DESCRIPTION OF THE DRAWINGS

FIG. 1, a schematic view of an example of a computer for implementing a method of monitoring a system,

FIG. 2, a flowchart of an example of implementation of a method of monitoring a system, and

FIG. 3 is a schematic representation of an example of a time series comprising a normal time period and an abnormal time period, each among the normal time period and the abnormal time period comprising a first and a second sub-period.

### DETAILED DESCRIPTION

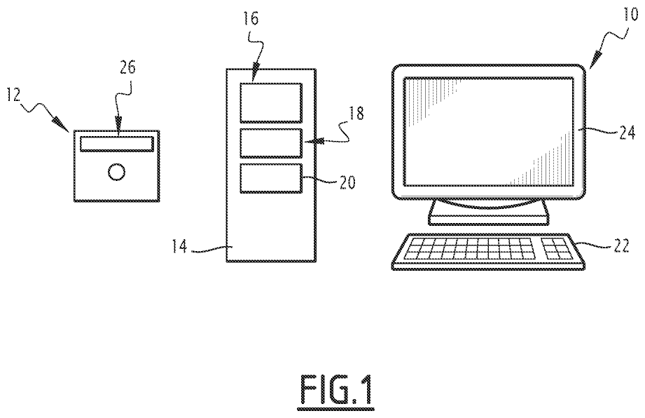

A calculator 10 and a computer program product 12 are shown in FIG. 1.

The calculator 10 is preferentially a computer.

More generally, the calculator 10 is an electronic calculator suitable for handling and/or transforming data represented as electronic or physical quantities in registers of the calculator 10 and/or memories into other similar data corresponding to physical data in memories, registers or other types of display, transmission or storage.

The calculator 10 interacts with the computer program product 12.

As shown in FIG. 1, the calculator 10 includes a processor 14 comprising a data processing unit 16, memories 18 and a data storage medium 20. In the example illustrated in FIG. 1, the calculator 10 comprises a keyboard 22 and a display unit 24.

The computer program product 12 includes a storage medium 26.

The storage medium 26 is a medium readable by the calculator 10, usually by the data processing unit 16. The readable storage medium 26 is a medium suitable for storing electronic instructions and apt to be coupled to a bus of a computer system.

As an example, the storage medium 26 is a diskette or a floppy disk, an optical disk, a CD-ROM, a magneto-optical disk, a ROM, a RAM, an EPROM, an EEPROM, a magnetic card or an optical card.

The computer program 12 containing program instructions is stored on the storage medium 26.

The computer program 12 can be loaded into the data processing unit 16 and is suitable for leading to the implementation of a method of monitoring a system when the computer program 12 is implemented on the processing unit 16 of the calculator 10.

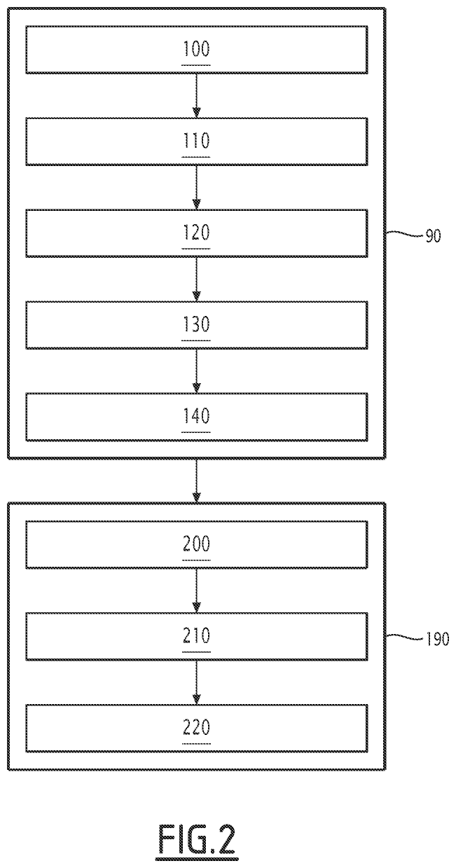

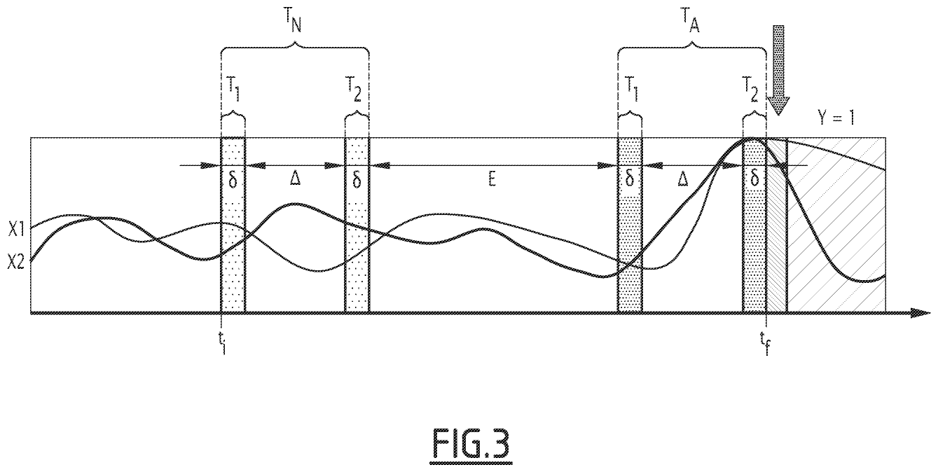

The operation of the calculator 10 will now be described with reference to FIG. 2 which schematically illustrates an example of implementation of a method of monitoring a system, and to FIG. 3 which is an example illustrating certain steps of the method.

The monitoring method aims to monitor a system, i.e. to initiate actions relating to the control of the system. In one example, the system is a distillation column, and abnormal events that may interfere with the normal operation of the distillation column are column chokings.

The monitoring method is e.g. implemented by the calculator 10 in interaction with the computer program 12, i.e. is implemented by computer.

The monitoring method comprises a preparation phase 90 and an operating phase 190. The preparation phase 90 is used for obtaining association rules predicting the occurrence or lack of occurrence of an abnormal event on the basis of the time evolution of one or a plurality of parameters X₁, . . . , Xₙ of the system to be monitored. Phase 190 is used for predicting the occurrence or lack of occurrence of an abnormal event likely to affect the system to be monitored as a function of the association rules and data relating to the time evolution of the predetermined parameter(s) X₁, . . . , Xₙ of the system to be monitored. Phase 190 is e.g. implemented in real time during the operation of the system to be monitored.

The preparation phase 90 comprises a step 100 for obtaining time series for at least one system of the same nature as the system to be monitored. The term “of the same nature” means that the system or systems are equivalent to the system to be monitored. The time series are e.g. obtained by measurements made by sensors.

Each time series describes the time evolution of one or a plurality of predetermined X₁, . . . , Xₙ of the system considered between an initial instant tᵢ and a final instant tᵣ. The final instant tᵣ is triggered by the occurrence of an abnormal event affecting the system in question. Each time series has a duration greater than a predetermined duration.

For example, each time series is the result of a division of a parent time series obtained for a system over a long time period (typically several days). The slicing is done so that the end of each time series coincides with the occurrence of an abnormal event.

In the case of a distillation column, the predetermined time is e.g. greater than or equal to 20 hours.

In the case of a refining unit such as a distillation column, the predetermined parameters X₁, . . . , Xₙ are e.g. selected from: different temperatures upstream or in the distillation column at different levels, different liquid pressures upstream or in the distillation column at different levels, flow rates, the type of raw liquid at the inlet of the distillation column, the openings of different valves upstream or in the column, and chemical or quality parameters. All such parameters are measured at a given frequency (sometimes close to real-time for some of the parameters) at different locations of the process not far from the distillation column.

In FIG. 3, a time series is illustrated as an example. More particularly, the time evolution of two predetermined parameters X1 and X2 is illustrated in FIG. 3.

The preparation phase 90 comprises a step 110 for defining an abnormal time period T_{A} and a normal time period T_{N} for each time series.

The abnormal time period T_{A} occurs immediately before the occurrence of the abnormal event. Thereby, the end of the abnormal time period T_{A} coincides with the triggering of the abnormal event, and thus the final instant tᵣ of the time series considered.

The normal time period T_{N} is an earlier period and of the same duration as the abnormal time period T_{A}. The normal time period T_{N} is such that the time gap E between the normal time period T_{N} and the abnormal time period T_{A} is greater than or equal to a predetermined gap. The time gap E is chosen so that the normal time period T_{N} is very far from the abnormal time period T_{A}.

For example, in the case of a distillation column, for a time series with a duration greater than or equal to 20 hours, the time gap E is greater than or equal to 5 hours, preferentially greater than or equal to 10 hours.

An example of an abnormal time period T_{A}, of a normal time period T_{N} and of a time gap E are illustrated in FIG. 3.

The preparation phase 90 comprises a step 120 of determining, for each time series, a metric characterizing each parameter X₁, . . . , Xₙ of the series considered, on the one hand over the abnormal time period T_{A}, and on the other hand over the normal time period T_{N}.

Step 120 is thereby used for obtaining data according to a case cross-over design, i.e. that the characterizing metrics obtained for each time series are directly comparable because same are obtained on the same system during the same process. Indeed, the comparison of parameter characteristics between normal time periods T_{N} and abnormal time periods T_{A} makes it possible to estimate the regular changes that induce an abnormal event.

The characterization metric of a parameter X₁, . . . , Xₙ is a quantity characterizing the parameter X₁, . . . , Xₙ over the period considered. For example, the characterization metric is a mean, a standard deviation, a residue, or further a rate of change.

The mean is the mean value of the parameter X₁, . . . , Xₙ considered over the duration of the normal or the abnormal time period considered.

The standard deviation is the value of the standard deviation of the parameter X₁, . . . , Xₙ considered over the duration of either the normal or the abnormal time period considered.

The residue is the error between the prediction made by a prediction model of a value of the parameter X₁, . . . , Xₙ considered over the duration of the normal or abnormal time period considered and the actual value of the parameter over the period considered. The prediction model is e.g. an autoregressive model, i.e. a model previously trained on a part of the data of the time series considered (but not the data relating to the normal or the abnormal time period considered).

The rate of change of a parameter X₁, . . . , Xₙ is a quantity quantifying the changes (variations) of the parameter X₁, . . . , Xₙ over the period considered. An example of a rate of change is described more specifically hereinafter.

In an example of implementation, the determination step 120 comprises the definition of a first sub-period T₁ and a second sub-period T₂ for each of the normal time period T_{N} and the abnormal time period T_{A} of each time series.

The second sub-period T₂ has the same duration δ as the first sub-period T₁ and is spaced from the first sub-period T₁ by a predetermined time difference Δ.

In the case of a distillation column, the duration δ is e.g. greater than or equal to one hour and the predetermined duration A is e.g. greater than or equal to two hours.

In the example of implementation, the determination step 120 comprises the calculation, for each normal time period T_{N} and abnormal time period T_{A}, of a datum characteristic of each parameter X₁, . . . , Xₙ considered over the duration δ, of the first sub-period T₁ and of the second sub-period T₊₂ of the time period considered. In other words, at the end of the calculation, four characteristic data are obtained for each parameter X₁, . . . , Xₙ of each time series, namely: a characteristic datum over the first sub-period T₁ of the normal time period T_{N}, a characteristic datum over the second sub-period T₂ of the normal time period T_{N}, a characteristic datum over the first sub-period T₁ of the abnormal time period T_{A} and a characteristic datum over the second sub-period T₂ of the abnormal time period T_{A}.

The characteristic datum considered is e.g. the mean, the standard deviation or the residue of the parameter X₁, . . . , Xₙ considered over the duration δ of the normal or the abnormal time period considered. Preferentially, the characteristic datum is the mean.

In the example of implementation, the rate of change of each normal time period T_{N} and abnormal time period T_{A} is then determined depending on the characteristic data obtained for the first sub-period T₁ and the second sub-period T₂ of the time period considered.

When the characteristic datum considered is the mean of each parameter X₁, . . . , Xₙ considered over the duration δ of the first sub-period T₁ and of the second sub-period T₂ of the time period considered, the rate of change is e.g. given by the following formula:

$$τ = \vert \frac{max ( \overline{{x}_{1}} , \overline{{x}_{2}} ) - min ( \overline{{x}_{1}} , \overline{{x}_{2}} )}{max ( \overline{{x}_{1}} , \overline{{x}_{2}} )} \vert \qquad ( 1 )$$

Where:
   τ refers to the rate of change of the parameter X over the time period considered, τ is comprised between 0 and 1,
   x̅₁̅ refers to the average of the parameter X over the first sub-period T₁ of the time period considered,
   x̅₂̅ refers to the mean of the parameter X over the second sub-period T₂ of the time period considered,
   max(x̅₁̅, x̅₂̅) refers to the maximum between x̅₁̅ and x̅₂̅, and
   min(x̅₁̅, x̅₂̅) refers to the minimum between x̅₁̅ and x̅₂̅.

The preparation phase 90 comprises a step 130 for determining association rules as a function of the characterizing metrics obtained for each parameter X₁, . . . , Xₙ of a set of time series, called training series. The set of training time series is such that at least one time series does not belong to the set so that same can be used as a test time series.

The association rules are e.g. determined from an Association Rules Mining algorithm. An example of algorithm used is the Apriori algorithm.

Each association rule predicts the occurrence or lack of occurrence of an abnormal event by associating data relating to the characterization metric of at least one parameter X₁, . . . , Xₙ with the occurrence or lack of occurrence of the abnormal event. The association rules are preferentially in the form of an implication, i.e. of the type a→b with a a set of elements and b another element that does not belong to the set of elements. In particular, in the present case, a denotes a set of data relating to the characterization metric of one or a plurality of parameters X₁, . . . , Xₙ and b denotes an abnormal event or the absence of an abnormal event.

In an example of implementation of the determination step 130, the characterizing metrics obtained are classified into a plurality of classes according to the value of the metric. Such is particularly the case when the characterizing metrics are quantities taking continuous values, as is the case for the mean, the standard deviation, the residue and the rate of change.

For example, when the characterization metric is a rate of change, the classes quantify the magnitude of the change. For example, for rates of change the value of which is comprised between 0 and 1, the values obtained for each parameter X₁, . . . , Xₙ of each time period are assigned to one of at least two classes.

In a specific example, at least three classes are defined, namely a “low” class, a “medium” class and a “high” class. The low class groups together the rates of change the value of which is comprised between the quantiles 0 and 0.33. The medium class groups together the rates of change the value of which is comprised between the quantiles 0.33 and 0.66. In the high class, the rates of change are included between the quantiles 0.66 and 1. Thus, for each training time series, each parameter X₁, . . . , Xₙ considered is assigned three pieces of information for the abnormal time period T_{A}, namely: a first piece of information relating to the veracity or otherwise of the fact that the rate of change of the parameter X₁, . . . , Xₙ over the abnormal period T_{A} is comprised in the low class, a second piece of information relating to the veracity or otherwise of the fact that the rate of change of the parameter X₁, . . . , Xₙ over the abnormal period T_{A} is comprised in the medium class, a third piece of information relating to the veracity or non-veracity of the fact that the rate of change of the parameter X₁, . . . , Xₙ over the abnormal time period T_{A} is comprised in the high class. In the same way, three pieces of information are also obtained for the parameter X₁, . . . , Xₙ over the normal time period T_{N}.

In the example of implementation, the association rules then associate a class of a characterization metric (e.g. rate of change) of at least one parameter X₁, . . . , Xₙ with the occurrence or lack of occurrence of an abnormal event.

For example, a rule has the following form:

$$\{ {X}_{\{ 0 ; 0.33 \}}^{( 1 )} = true , {X}_{\{ 0.33 ; 0.66 \}}^{( 2 )} = false \} \text{=>} \{ Y = 1 \} \qquad ( 2 )$$

Where:
   X_{[0;0.33]}⁽¹⁾=true refers to a first parameter X₁ the value of rate of change of which is comprised in the low class,
   X_{[0.33;0.66]}⁽²⁾=false refers to a second parameter X₂ the value of rate of change of which is not comprised in the medium class, and
   Y=1 refers to the occurrence of an abnormal event, the absence of an abnormal event being referred to by Y=0.

The previous rule thus reads as follows: if the first parameter X₁ has a rate of change comprised in the low class and the second parameter X₂ has a rate of change that is not comprised in the medium class, then the rule predicts the occurrence of an abnormal event.

In the above example and description, at least part of the association rules predict the occurrence of an abnormal event. In an advantageous mode of implementation, the other (non-zero) part of the association rules predict the absence of an abnormal event.

Preferentially, the determined association rules include at most a predetermined number of rules, selected from a set of rules established on the basis of the characterizing metrics of the parameters X₁, . . . , Xₙ over the set of training time series. The predetermined number is e.g. equal to ten.

Thereby, a set of rules is first established, e.g. by means of an Apriori algorithm. The rules are e.g. of different types, and only rules predicting the occurrence or the absence of an abnormal event are retained. Then, at most a number of rules corresponding to the predetermined number are selected. For example, the selected rules are rules satisfying first a first criterion, preferentially also a second criterion, preferentially also a third criterion and preferentially further a fourth criterion.

The first criterion states that the selected rules are rules the frequency of occurrence of which (a “support”) in the time series considered is greater than an occurrence threshold. The frequency of occurrence is e.g. calculated by a metric called support. The support is e.g. defined as follows:

$$supp ( a \to b ) = \frac{\# ( a ⋃ b )}{\vert D \vert} \qquad ( 3 )$$

Where:
   supp(a→b) refers to the support, i.e. the frequency of occurrence of a in b for all normal time periods when b denotes the absence of an abnormal event, and for all abnormal time periods when b denotes the occurrence of an abnormal event, supp(a→b) is broadly comprised between 0 and 1,
         |D| refers to the number of normal time periods when b denotes the absence of an abnormal event, and abnormal time periods when b denotes the occurrence of an abnormal event, and
   #(a∪b) refers to the number of elements of D that contain the set a∪b.

The second criterion states that the selected rules are the rules having a metric, called confidence range, the highest among the rules the frequency of occurrence of which in the time series considered is greater than an occurrence threshold. The confidence metric evaluates the frequency of veracity of the rule over the time series considered. The confidence metric is e.g. defined as:

$$conf ( a \to b ) = \frac{supp ( a \to b )}{supp ( a )} \qquad ( 4 )$$

Where:
   conf(a→b) refers to the confidence metric, i.e. the percentage of normal time periods (where b denotes the absence of an abnormal event) or of abnormal time periods (where b denotes the occurrence of an abnormal event) containing a that also contain b, conf (a→b) is broadly comprised between 0 and 1, and
   supp(a) refers to the frequency of occurrence of a in normal time periods when b denotes the absence of an abnormal event, and in abnormal time periods when b denotes the occurrence of an abnormal event, supp(a) is broadly comprised between 0 and 1.

The third criterion states that the rules selected are the rules having the lowest independence rate among the rules the frequency of occurrence in the time series considered is greater than an occurrence threshold and the confidence metric of which is the highest. The independence rate quantifies the lift of associations made by a rule. The independence rate is e.g. defined as follows:

$$lift ( a \to b ) = \frac{supp ( a \to b )}{supp ( a ) \cdot supp ( b )} \qquad ( 5 )$$

Where:
   lift(a→b) refers to the independence rate, i.e. the support that would have been obtained if a and b were independent, lift(a→b) is comprised between 0 and infinity so that if the independence rate is close to one, it means that a and b are independent, and if the independence rate is higher or close to zero, it means that a and b are associated, and
   supp(b) refers to the frequency of occurrence of b in normal time periods when b designates the absence of an abnormal event, and in abnormal time periods when b designates the occurrence of an abnormal event, supp(b) is broadly between 0 and 1.

The fourth criterion states that the selected rules are the rules having a metric, called conviction range, the highest among the rules the frequency of occurrence of which in the time series considered is greater than an occurrence threshold, the confidence metric of which is the highest and the independence rate of which is the lowest. The conviction metric quantifies the frequency of non-veracity of the rule over the time series considered. The conviction metric is, e.g., defined as:

$$conv ( a \to b ) = \frac{1 - supp ( b )}{conf ( a \to b )} \qquad ( 6 )$$

Where:
   conv(a→b) refers to the conviction metric, i.e. the frequency that a occurs without b, conv(a→b) is comprised between zero and infinity, a high value obtained for the conviction metric indicates that the association is relevant.

The preparation phase 90 comprises a step 140 of validation of the association rules obtained over at least one time series, called a test time series, distinct from the training time series.

If, at the end of the validation step 140, the rules are not validated, then the method is e.g. reiterated from the step of determination of the association rules. In such case, a different predetermined threshold is e.g. set for the support (metric).

In an example of implementation, during the validation step, for each time series considered, a prediction is obtained for each of the association rules on the test time series. Such a prediction is e.g. obtained on the basis of characterizing metrics obtained for the parameters X₁, . . . , Xₙ of the test time series over each of the normal and the abnormal time periods.

The final prediction is obtained by aggregating the predictions obtained for each of the association rules according to an aggregation criterion. The aggregation criterion states e.g. that the final prediction is the predominant prediction obtained. In another example, the aggregation criterion states that the final prediction predicts the occurrence of an abnormal event when at least one rule predicts the occurrence of such an abnormal event. The association rules are validated when the final prediction matches the proven prediction of an abnormal event over the test time series.

When the test is performed on a plurality of test series, the rules are e.g. validated when the rules are validated for each test series, or at least for a predetermined percentage of the test series (e.g. 80%).

In an example of implementation, when the association rules comprise rules predicting the occurrence of an abnormal event (first type of rules) and rules predicting the absence of an abnormal event (second type of rules, or contraposed), a final prediction is obtained for rules of the first type, and for rules of the second type. The association rules are then validated e.g. when the final predictions obtained for each type of rules are proven.

In an example of implementation, the preparation phase comprises the repetition of the steps of determining association rules and validation rules for different sets of training time series so that each time series was once a test time series and during the other repetitions a training time series. Such approach makes it possible to perform a cross-validation, and thereby make use of all the time series for both training and testing. The rules are e.g. validated when, at the end of the repetitions, the rules are validated for each test series, or at least for a predetermined percentage of the test series (e.g. 80%).

The operating phase 190 is implemented once the association rules have been validated. The operating phase is e.g. implemented in real-time on a system so as to predict in advance the occurrence of an abnormal event likely to affect the system (choking in the case of a distillation column).

The operating phase 190 comprises a step 200 for obtaining data relating to the time evolution of the predetermined parameter(s) X₁, . . . , Xₙ of the system to be monitored. The data are e.g. obtained by measurements made by sensors (e.g. temperature, pressure and flow sensors in the case of a distillation column).

The operating phase 190 comprises a step 210 of predicting the occurrence or lack of occurrence of an abnormal event likely to affect the system on the basis of the data obtained for the system to be monitored and of the validated association rules.

The prediction is e.g. performed by an analysis of the characterizing metrics (chosen depending on the characterizing metrics considered for the association rules) of the parameters X₁, . . . , Xₙ considered of the system over the last time period for which measurements were made (advantageously, the duration of the last time period is equal to the duration of the normal time period T^{N} and the abnormal time period T_{A} of the training phase). Depending on the characterizing metrics obtained, the previously validated association rules predict or do not predict the occurrence of an abnormal event (the final prediction is e.g. obtained by aggregating the predictions of each rule according to the aggregation criterion).

Optionally, the operating phase comprises a step 220 of generating an alert and/or triggering a control action on the system when an abnormal event is predicted.

Thereby, the present method implements an original use (in the form of a case cross-over design) of data relating to a system so as to extract association rules predicting the occurrence or lack of occurrence of an abnormal event. The association rules thereby make it possible to better understand the causes (combinations of parameter values X₁, . . . , Xₙ) leading to an abnormal event.

Such a method thereby leads to a better prediction of the occurrence of an abnormal event affecting a system. More particularly, compared to the prediction models of the prior art, such a method makes it possible to reduce false positives (erroneous prediction) and false negatives (absence of prediction), and to better identify the parameters X₁, . . . , Xₙ or operating characteristics apt to trigger an abnormal event.

In the case of distillation columns, such a method makes it possible to provide an early warning to an operator since pre-choking is detected and not a choking as such, which allows the operator to react before the choking occurs and is a source of leakage or at the very least loss of distillation column yield and reduces the downtime of the distillation column which could choke and the safety of the associated distillation process.

Furthermore, a person skilled in the art would understand that the present method is applicable to multiple applications, not only to monitoring the choking of distillation columns but also to other applications, such as monitoring the damage or deterioration of systems, or to perform prescriptive and predictive maintenance.

1. A method of monitoring a system, the method being implemented by computer and comprising:
a. a preparation phase comprising the following steps:
i. obtaining time series, for at least one system of the same nature as the system to be monitored, each time series describing the time evolution of one or a plurality of predetermined parameters of the system considered between an initial instant and a final instant, the final instant being triggered by the occurrence of an abnormal event affecting the system in question,
ii. for each time series, the definition of an abnormal time period and a normal time period, the end of the abnormal time period coinciding with the occurrence of the abnormal event, the normal time period being an earlier period having the same duration as the abnormal time period and such that the time gap between the normal time period and the abnormal time period is greater than a predetermined gap,
iii. for each time series, the determination of a metric characterizing each parameter of the series considered, on the one hand over the abnormal time period, and on the other hand over the normal time period,
iv. for a set of time series, called training series, the determination of association rules according to the characterizing metrics obtained for each parameter, each association rule predicting the occurrence or lack of occurrence of an abnormal event by associating data relating to the characterization metric of at least one parameter with the occurrence or lack of occurrence of the abnormal event,
v. the validation of the association rules obtained on at least one time series, called test series, distinct from the training time series,
b. an operating phase comprising the following steps:
i. obtaining data relating to the time evolution of the predetermined parameter(s) of the system to be monitored,
ii. predicting the occurrence or lack of occurrence of an abnormal event likely to affect the system based on the data obtained for the system to be monitored and the validated association rules.

2. The method according to claim 1, wherein for each normal time period and each abnormal time period, a first sub-period and a second sub-period are defined, the second sub-period having the same duration as the first sub-period and being spaced from the first sub-period by a predetermined duration, the characterization metric being a rate of change, during the step of determining the characterization metric, for each normal and abnormal time period, a characteristic datum for each parameter considered over the period of the first sub-period and of the second sub-period of the time period considered being calculated, the characterization metric of each normal and abnormal time period being obtained on the basis of the characteristic data obtained for the first sub-period and the second sub-period of the time period considered.

3. The method according to claim 1, wherein in the step of determining the association rules, the characterizing metrics are classified into a plurality of classes according to the value obtained for each characterization metric, during the step of determining the association rules, the data relating to the characterization metric being the class to which the characterization metric belongs so that each association rule associates a class of a characterization metric of at least one parameter with the occurrence or lack of occurrence of an abnormal event.

4. The method according to claim 1, wherein the determined association rules are at most a predetermined number of rules selected from a set of rules established depending on the characterizing metrics of the parameters over all training time series, the selected rules being rules, the frequency of occurrence of which in the time series considered is greater than an occurrence threshold.

5. The method according to claim 1, wherein, during the validation step, a prediction is obtained for each of the association rules on the test time series considered, the final prediction being obtained by aggregating the predictions obtained for each of the association rules according to an aggregation criterion, the association rules being validated when the final prediction corresponds to the proven prediction of an abnormal event in the test time series.

6. The method according to claim 1, wherein the association rules comprise rules predicting the occurrence of an abnormal event and rules predicting the absence of an abnormal event.

7. The method according to claim 1, wherein the preparation phase comprises repeating the steps of determining association rules and validating for different sets of training time series so that each time series was once a test time series and during the other repetitions a training time series.

8. The method according to claim 1, wherein the operating phase comprises a step of generating an alert and/or initiating a system control action when an abnormal event is predicted.

9. The method according to claim 1, wherein the system to be monitored is a distillation column and the abnormal event is a choking of the distillation column.

10. (canceled)

11. The method according to claim 4, wherein the selected rules are the rules having the highest confidence metric among the rules, the frequency of occurrence in the time series considered being greater than an occurrence threshold, the confidence metric evaluating the frequency of veracity of the rule over the time series considered.

12. The method according to claim 4, wherein the selected rules are the rules with the lowest independence rate among the rules, the frequency of occurrence of which in the time series considered being greater than an occurrence threshold and the confidence metric of which being the highest, the independence rate quantifying the independence of associations made by a rule.

13. The method according to claim 4, wherein the selected rules are the rules with the highest conviction metric among the rules, the frequency of occurrence of which in the time series considered being greater than an occurrence threshold, the confidence metric of which being the highest and the independence rate of which being the lowest, the conviction metric quantifying the frequency of non-veracity of the rule over the time series considered.

14. A readable information medium on which a computer program product according to claim 1 is stored.
